(19) United States
(12) Patent Application Publication
(10) Pub. No.: US 2026/0320867 A1
(43) Pub. Date: Oct. 15, 2026

(54) TEXT-TO-IMAGE SYNTHESIS OF ARBITRARY STYLES

(71) Applicant: Google LLC, Mountain View, CA (US)

(72) Inventors: Kihyuk Sohn, Sunnyvale, CA (US); Dilip Krishnan, Mountain View, CA (US); Kimin Lee, Santa Clara, CA (US)

(21) Appl. No.: 19/485,073

(22) PCT Filed: May 17, 2024
(86) PCT No.: PCT/US2024/029972

§ 371 Date: Nov. 17, 2025

Related U.S. Application Data
(60) Provisional application No. 63/467,281, filed on May 17, 2023.

(51) Int. Cl. G06T 11/60; G06F 40/289

(52) U.S. Cl. CPC G06T 11/60; G06F 40/289

(57) ABSTRACT

Methods, systems, and apparatus, including computer programs encoded on computer storage media, for generating an output image using a text-to-image generative model from a text prompt. The text-to-image generative model includes one or more first sets of parameters that are shared across different styles. The text-to-image generative model also includes one or more second sets of parameters that are specific to the specified style.

### CROSS-REFERENCE TO RELATED APPLICATION

This application claims priority to U.S. Provisional Application No. 63/467,281, filed on May 17, 2023. The disclosure of the prior application is considered part of and is incorporated by reference in the disclosure of this application.

### BACKGROUND

This specification relates to processing images using neural networks.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that implements a text-to-image generative model configured to generate an image conditioned a text prompt.

In some cases, the text prompt specifies a particular style of the image, the text-to-image generative model processes the text prompt to generate an image having the particular style specified by the text prompt. In some cases, the text prompt specifies a particular object (e.g., a particular person, a particular animal, a particular car, a particular boat, etc.) or specific instance of an object that should appear in the image, the text-to-image generative model processes the text prompt to generate an image depicting the particular object/instance specified by the text prompt. In some other cases, the text prompt specifies both the particular style of the image and the particular object/instance that should appear in the image, the text-to-image generative model processes the text prompt to generate an image having (i) the particular style and (ii) depicting the particular object/instance.

Particular embodiments of the subject matter described in this specification can be implemented so as to realize one or more of the following advantages. The system as described in this specification implements a text-to-image generative model that is easily generalizable across a diversity of image styles. The described system allows users to adapt the text-to-image generative model to a particular style by providing very few, sometimes as few as one, images as reference images of the particular style. Augmented with one or more style-specific adapters that are inserted within each of one or more layers of the model, the text-to-image generative model can be effectively and efficiently fine-tuned to adapt to the particular style because only a small proportion of the parameters of the model, which are specific to the style of the image that the model is generating, will need to be learned. The adaptation process is therefore much less computationally intensive than the pre-training process. Thus, unlike the pre-training process which typically has to be performed at a distributed computing system, e.g., a datacenter, the adaptation process can be performed on much less powerful hardware, e.g., a mobile phone or another wearable device, a desktop or laptop computer, or another internet-enabled device installed in a user's home, to name just a few examples. The text-to-image generation system described herein provides a better disentanglement of content and style and as such, is better able to generate images having particular objects and/or style specified in a user prompt. In general, an improved text-to-image generation system is provided as the system is better able to generate an image according to the instructions provided by a user in the user prompt.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example image generation system that includes a text-to-image generative model.

FIG. 1B is a diagram that illustrates an example architecture for performing inference using a text-to-image generative model.

FIG. 1C is a diagram that illustrates an example architecture for fine-tuning a text-to-image generative model.

FIG. 2 is a flow diagram of an example process for generating an output image by using a text-to-image generative model.

FIG. 3 is a flow diagram of sub-steps of one of the steps of the process of FIG. 2.

FIG. 4 is a flow diagram of another example process for generating an output image by using a text-to-image generative model.

FIG. 5 is a flow diagram of sub-steps of one of the steps of the process of FIG. 4.

Like reference numbers and designations in the various drawings indicate like elements.

### DETAILED DESCRIPTION

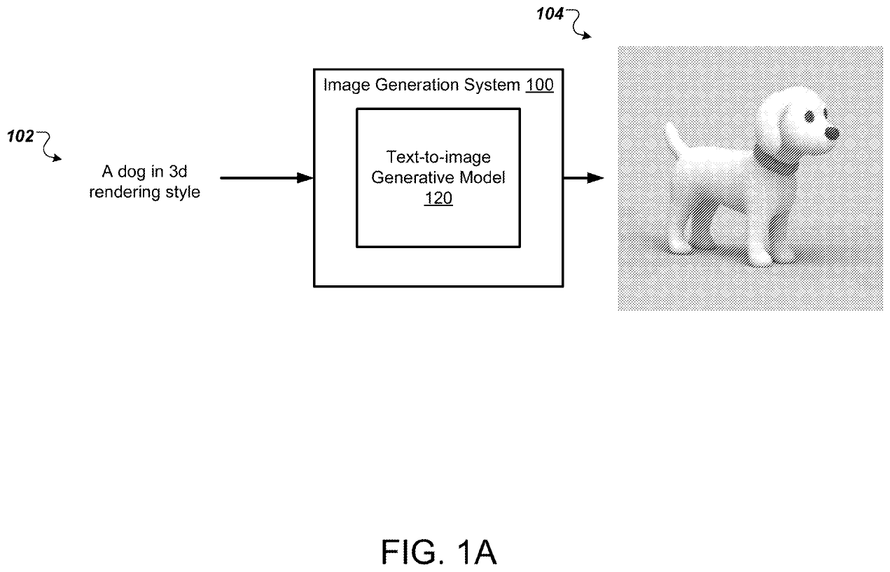

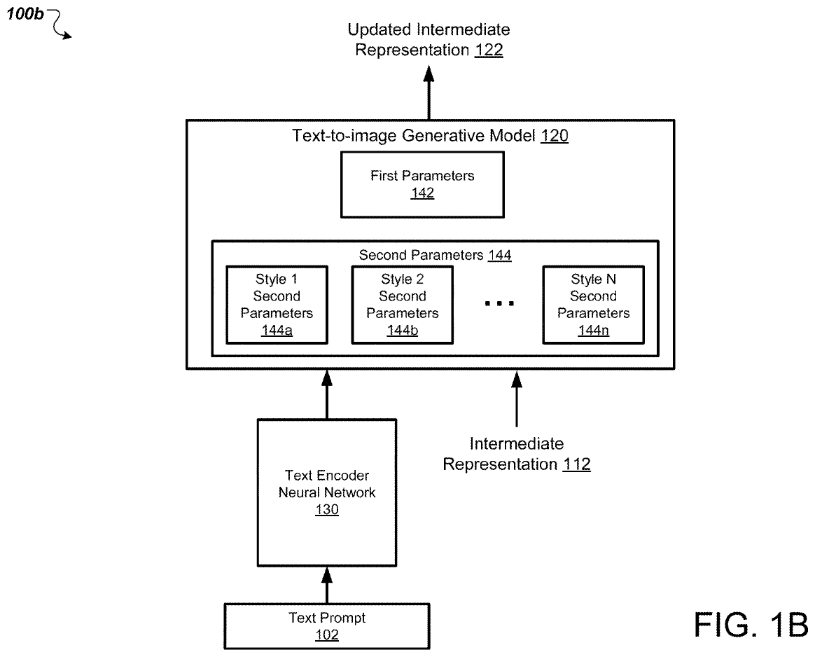

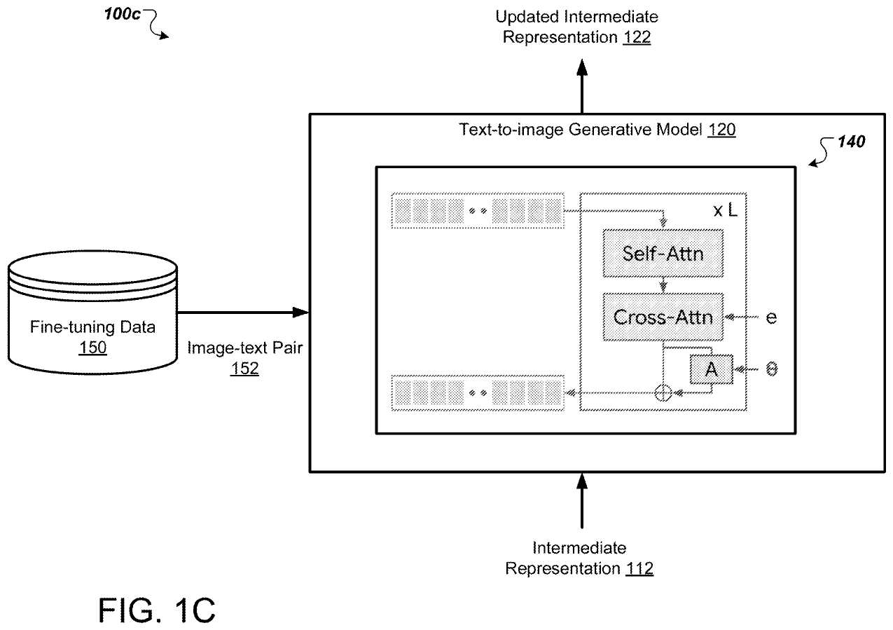

FIG. 1A shows an example image generation system 100 that includes a text-to-image generative model 120. The image generation system 100 is an example of a system implemented as computer programs on one or more computers in one or more locations in which the systems, components, and techniques described below are implemented.

The image generation system 100 receives a text prompt 102 from a user of the system and generates an output image 104 based on the text prompt 102 by using text-to-image generative model 120. The text prompt 102 specifies a particular style of the output image 104 and, in some cases, a particular object (e.g., a particular person, a particular animal, a particular car, a particular boat, a particular house, etc.) that should appear in the output image 104. Optionally, in some cases, the text prompt 102 further includes a negative prompt that specifies the content, e.g., objects, that should not appear in the output image 104.

The output image 104 is an image that is described by the text prompt 102. That is, the output image 104 has the particular style and, in some cases, depicts the particular object specified in the text prompt 102.

As used herein, an “image” can mean a digital image, such as a two-dimensional image or a three-dimensional image, or even consecutive frames of video. An image can have multiple pixels, where each pixel can have multiple values.

As used herein, a “style” of an image specifies a particular set of appearance features including, e.g., color, texture and brightness in the image, including color arrangement, light and dark transition, shading, and texture features, represented in images having the image style. Different images having different image styles are usually visually distinguishable from each other. For example, photos, cartoons, caricatures, oil paintings, sketches, watercolor, flat illustrations, and 3D rendering may be considered as different image styles. The style of the image may not include the geometries of the objects in the image.

As illustrated in FIG. 1A, the image generation system 100 receives the following as text prompt 102: “a dog in 3d rendering style.” The image generation system 100 then uses the text prompt 102 and the text-to-image generative model 120 to generate an output image 104 which depicts a dog in 3d rendering style. In this example, the text prompt 102 specifies both a particular style of the image (“3d rendering style”) and a particular object (“a dog”) that should appear in the image.

For example, the image generation system 100 can provide the output image 104 for presentation to a user on a user computer, e.g., as a response to the user who submitted the text prompt 102. As another example, the image generation system 100 can store the output image 104 in a repository for later use.

FIG. 1B is a diagram that illustrates an example architecture 100b for performing inference using the text-to-image generative model 120. In addition to the text-to-image generative model 120, the architecture 100b also includes a text encoder neural network 130 and, in some cases, an image encoder neural network and an image decoder neural network. The components illustrated in FIG. 1B can be implemented by a system implemented as computer programs on one or more computers in one or more locations, e.g., the image generation system 100.

The text-to-image generative model 120 can be configured to map a text prompt 102 to an output image 104 in any of a variety of ways. In some implementations, the text-to-image generative model 120 can be configured to do so by performing a reverse diffusion process in a pixel space during which noise is progressively removed from a noisy version of the output image to provide the output image, e.g., as described in Chitwan Saharia, et al. Photorealistic text-to-image diffusion models with deep language understanding. Advances in Neural Information Processing Systems, 35:36479-36494, 2022.

In these implementations, at each of multiple reverse diffusion steps across the reverse diffusion process, the text-to-image generative model 120 generates an updated intermediate representation 122 of the output image based on either an intermediate representation 112 of the output image that has been generated as of a previous reverse diffusion step or a predetermined, initial intermediate representation of the output image (when the reverse diffusion step is the first reverse diffusion step in the reverse diffusion process).

The updated intermediate representation 122 can either be generated directly, e.g., where the model output of the text-to-image generative model 120 includes the updated intermediate representation, or indirectly, e.g., where the model output includes a noise term computed by the model for the reverse diffusion step, and the updated intermediate representation can then be generated by removing at least some of the noise from the intermediate representation 112 in accordance with the noise term. The noise term is an estimate of the noise, as computed by the model, that has been added to the output image to arrive at the noisy version of the output image.

In some other implementations, the text-to-image generative model 120 can be configured to do so by performing a reverse diffusion process in a latent space, e.g., in a latent space that is lower-dimensional than the pixel space, during which noise is progressively removed from a noisy version of a latent image to provide the latent image, e.g., as described in Aditya Ramesh, et al. Hierarchical text-conditional image generation with clip latents. arXiv preprint arXiv:2204.06125, Robin Rombach, et al. High-resolution image synthesis with latent diffusion model, Proceedings of the IEEE/CVF conference on computer vision and pattern recognition. 2022. The values for the pixels in the latent image include learned, latent values rather than color values.

In these implementations, at each of multiple reverse diffusion steps across the reverse diffusion process, the text-to-image generative model 120 generates, i.e., either directly or indirectly, an updated intermediate representation 122 of the latent image based on either an intermediate representation 112 of the latent image that has been generated as of a previous reverse diffusion step or a predetermined, initial intermediate representation of the output image (when the reverse diffusion step is the first reverse diffusion step in the reverse diffusion process).

Moreover, in these implementations, the text-to-image generative model 120 can be associated with an image encoder neural network to encode images into the latent space and a decoder neural network that receives the latent image and decodes the latent image to generate an output image. For example, the image encoder neural network and the image decoder neural network can have been trained jointly on an image reconstruction objective, e.g., a VAE objective, a VQ-GAN objective, or a VQ-VAE objective.

In yet other implementations, the text-to-image generative model 120 can be configured to do so by iteratively predicting masked tokens over a decoding process in a discrete token space, e.g., as described in Huiwen Chang, et al. Muse: Text-to-image generation via masked generative transformers. arXiv preprint arXiv:2301.00704, 2023.

In these implementations, at each of multiple decoding steps during the decoding process, the text-to-image generative model 120 generates, based on an intermediate representation 112 of the output image that has been generated as of a previous decoding step, an updated intermediate representation 122 of the output image that includes a plurality of discrete visual tokens selected from a given vocabulary of discrete visual tokens.

The updated intermediate representation 122 can be generated based on gradually replacing mask tokens that were previously included in the intermediate representation 112 with discrete visual tokens selected from the given vocabulary of discrete visual tokens. Specifically, the model output can define, for each of at least some of multiple spatially distinct positions in the output image, one or more score distributions over the given vocabulary of discrete visual tokens, and the system can use the one or more score distributions to determine one or more discrete visual tokens that corresponds to the spatially distinct position. Once selected, the selected discrete visual tokens will then replace the mask tokens, i.e., will reside at the positions of the mask tokens in the intermediate representation.

The plurality of spatially distinct positions can include respective sub-sets of the output image (possibly overlapping subsets), which can be spatially displaced relative to each other. For example, each position can correspond to an image patch of the output image. An image patch of an output image is a subset of the pixels of the output image. Generally, each image patch includes multiple contiguous pixels of the output image.

In some implementations, the updated intermediate representation 122 at the final step can correspond to the output image 104 or as discussed above, the output image 104 can be derived from the updated intermediate representation 122 through suitable processing.

The text encoder neural network 130 is configured to process the text prompt 102 to generate one or more text embeddings based on the text prompt 102. An “embedding” as used in this specification is a sequence of one or more vectors of numeric values, e.g., floating point values or other values, each vector having a pre-determined dimensionality.

For example, when the text prompt 102 includes a description of a particular style that the output image should have, the text encoder neural network 130 can process the text prompt 102 to generate a contextual text embedding that corresponds to the description of the particular style.

As another example, when the text prompt 102 includes both a description of a particular object that should appear in the output image and a description of a particular style that the output image should have, the text encoder neural network 130 can process the text prompt 102 to generate two text embeddings: an object text embedding that corresponds to the description of the particular object, and a contextual text embedding that corresponds to the description of the particular style. In some implementations, the text prompt 102 can follow a particular format to enable the style to be identified from the text prompt 102 more easily.

The text encoder neural network 130 can include any appropriate types of neural network layers (e.g., embedding layers, fully connected layers, and so forth) in any appropriate number (e.g., 2 layers, or 5 layers, or 10 layers) and connected in any appropriate configuration (e.g., as a directed graph of layers). In implementations the text encoder neural network 130 can for example be configured as a feed-forward neural network, e.g., a Transformer neural network, or a recurrent neural network, e.g., a long short-term memory neural network.

The text-to-image generative model 120 can be configured to have any appropriate neural network architecture that enables it to process a model input that includes an intermediate representation 112 and the one or more text embeddings in accordance with the parameters of the text-to-image generative model 120 to generate, as model output, an updated intermediate representation 122.

In particular, the parameters of the text-to-image generative model 120 include one or more first sets of parameters 142 and a plurality of second sets of parameters 144. The one or more first sets of parameters 142 are shared across different styles. On the other hand, the one or more second sets of parameters 144a-n included in the plurality of second sets of parameters 144 are each specific to a different style.

For example, FIG. 1B illustrates that the plurality of second sets of parameters 144 includes (i) one or more second sets of parameters 144a that are specific to style 1, (ii) one or more second sets of parameters 144b that are specific to style 2, and so on, up to (iii) one or more second sets of parameters 144n that are specific to style N, where N is any integer greater than or equal to one.

To generate output images that have different styles, the text-to-image generative model 120 uses the same one or more first sets of parameters 142 but different ones of the one or more second sets of parameters 144a-n. Thus, output images having one style will be generated by a different combination of parameters of the text-to-image generative model 120 than output images having another style.

Put another way, some of the parameters of the text-to-image generative model 120 (that is, the one or more first sets of parameters 142) will be used to generate output images that have multiple different styles, while some others of the parameters of the text-to-image generative model 120 (for example, the one or more second sets of parameters 144a) will only be used to generate output images that have a particular style that corresponds to those parameters (for example, output images of style 1 that corresponds to the one or more second sets of parameters 144a).

In FIG. 1B, for example, to facilitate the generation of output images that have different styles, the text-to-image generative model 120 maintains the plurality of second sets of parameters 144 that correspond to different styles 1-N. Then, depending on the style specified by the received text prompt 102, the image generation system 100 selects, from the maintained plurality of second sets of parameters 144, one or more second sets of parameters, e.g., the one or more second sets of parameters 144a, that correspond to the specified style for use in performing inference computations using the text-to-image generative model 120, i.e., together with the one or more first sets of parameters 142.

For any particular style, prior to using the text-to-image generative model 120 to generate output images that have the particular style, the image generation system 100 or another training system fine-tunes the text-to-image generative model 120 to adapt the model to the particular style by learning updated values of the one or more second sets of parameters 144a-n that correspond to the particular style.

In some implementations, the text-to-image generative model 120 has been pre-trained, e.g., by the image generation system 100 or a different training system, on a set of training images based on optimizing a denoising score-matching objective, e.g., that uses a squared error loss (when configured to perform a reverse diffusion process), or based on optimizing a cross-entropy loss (when configured to perform a decoding process), to learn the pre-trained values of the one or more first sets of parameters 142 of the text-to-image generative model 120.

The one or more first sets of parameters 142 of the text-to-image generative model 120 can have been learned independently of the plurality of second sets of parameters 144 that correspond to different styles 1-N. That is, the plurality of second sets of parameters 144a-n were not used to process the training images during the pre-training of the text-to-image generative model 120, and thus were not learned jointly with the one or more first sets of parameters 142 during the pre-training.

FIG. 1C is a diagram that illustrates an example architecture 100c for fine-tuning the text-to-image generative model 120 on fine-tuning data 150. The components illustrated in FIG. 1C can be implemented by a system implemented as computer programs on one or more computers in one or more locations, e.g., the image generation system 100.

The fine-tuning data 150 includes one or more image-text pairs 152. Each image-text pair 152 includes (i) an image that has a particular style and (ii) a text prompt that includes both a description of the content of the image, e.g., an object that appears in the image, and a description of the particular style of the image. For example, the particular style can be the same style as the style that is specified in the text prompt 102 of FIG. 1A. In particular, because of the way that the text-to-image generative model 120 will be adapted to the particular style, the fine-tuning data 150 need only include a small number of, e.g., between one and ten, e.g., as few as one, image-text pair(s) 152.

The fine-tuning data can be obtained in any of a variety of ways. For example, the image generation system 100 can receive the fine-tuning data as an upload from a user of the system, e.g., the same user who provided the text prompt 102, over a data communication network, e.g., using an application programming interface (API) made available by the system. As another example, the image generation system 100 can receive an input from a user specifying which data that is already maintained by the system or another system that is accessible by the system should be used for fine-tuning the text-to-image generative model.

The exact architectures of the text-to-image generative model 120 may vary from implementations to implementations, but generally, the text-to-image generative model 120 includes multiple neural network layers, and the parameters of the text-to-image generative model 120 include respective parameters, e.g., the weights and, optionally, biases, of the layers of the text-to-image generative model 120.

At a high level, the one or more first sets of parameters 142 can include respective parameters of some of the layers of the text-to-image generative model 120. The respective parameters of these layers have been pre-trained, and will be held fixed to their pre-trained values during the fine-tuning process. The plurality of second sets of parameters 144 can include respective parameters of some others of the layers of the text-to-image generative model 120. The respective parameters of these other layers will be learned as part of the fine-tuning process.

As illustrated in FIG. 1C, in some implementations, the text-to-image generative model 120 includes L Transformer blocks 140, e.g., as part of a masked generative Transformer architecture, a diffusion Transformer (DiT) architecture, or a universal Vision Transformer (UViT) architecture amongst others. L is any integer greater than or equal to one. Each Transformer block 140 includes one or more attention layers, e.g., one or more self-attention layers, one or more cross-attention layers, or both, and an adapter (i.e. one or more additional neural network layers for adaptation to the particular style). Each Transformer block 140 is configured to process a block input derived from the intermediate representation to generate a block output based on applying an attention mechanism.

When there are multiple Transformer blocks, the Transformer blocks can be stacked, i.e., arranged in a sequence with the output of any Transformer block except the last being an input to another of the Transformer blocks. For example, the intermediate representation 112 can be received by the first Transformer block in the sequence of L Transformer blocks, and the updated intermediate representation 122 can be or be generated from the output of the last Transformer block in the sequence of L Transformer blocks.

In the example of FIG. 1C, each Transformer block 140 includes a self-attention layer (“Self-Attn”) followed by a cross-attention layer (“Cross-Attn”). The self-attention layer is configured to process an input to the Transformer block 140 by applying a self-attention mechanism to generate an output of the self-attention layer. The cross-attention layer is configured to process (i) the output of the self-attention layer and (ii) the one or more text embeddings that have been generated by the text encoder neural network 130 based on the text prompt 102, by applying a cross-attention mechanism, to generate an output of the cross-attention layer.

The adapter (“A”), in turn, includes one or more adapter layers that process the output of the cross-attention layer to generate an output of the adapter. In some implementations, the one or more adapter layers can include one or more fully connected layers. For example, the one or more adapter layers can include two feed-forward layers that each apply a linear transformation, separated by an activation layer that applies a non-linear activation function, e.g., a ReLU activation function, a GeLU activation function, or the like. The adapter can additionally or alternatively include other types of neural network layers, including convolutional layers, attention layers, pooling layers, for example.

In particular, the adapter is lightweight, namely it has a very limited number of parameters compared with the attention layers (or other model components). For example, the adapter can include an order of magnitude smaller number of parameters than the self-attention layer or the cross-attention layer included in the Transformer block 140.

In the example of FIG. 1C, each Transformer block 140 also includes a residual connection layer that combines the output of the last cross-attention layer with the output of the adapter to generate the output of the Transformer block 140. In some other examples where each Transformer block 140 does not include such a residual connection layer, the output of the last cross-attention layer can be used as the output of the Transformer block 140. In yet other examples where each Transformer block 140 includes additional components, e.g., a multi-layer perceptron layer(s), each Transformer block 140 can include additional adapters, e.g., an additional adapter having a similar architecture that is arranged subsequent to the multi-layer perceptron layer(s). The output of the Transformer block 140 can then be generated from, e.g., by combining, the output of the additional adapter and the output of the multi-layer perceptron layer(s).

In these implementations, the one or more first sets of parameters 142 that are shared across different styles include the parameters of the one or more attention layers included in each of the L Transformer blocks 140. In the example of FIG. 1C, the one or more first sets of parameters 142 thus include the parameters of the self-attention layer (“Self-Attn”) and the cross-attention layer (“Cross-Attn”) included in each of the L Transformer blocks 140.

The one or more second sets of parameters, e.g., the one or more second sets of parameters 144a, that are specific to the particular style include the parameters of the one or more adapter layers included in each adapter included in each of the L Transformer blocks 140. For example, the one or more second sets of parameters 144a can include the parameters of the feed-forward layers included in the adapter (“A”) in each of the L Transformer blocks 140.

While the parameters of the attention layers within each Transformer block are shared across many styles, the parameters of the layers within each adapter are specific to the particular style. In other words, different adapters will be used to generate images of different styles (but the same attention layers will be used throughout).

In some implementations, the text-to-image generative model 120 includes a plurality of convolutional blocks, e.g., ResNet blocks, that each include one or more convolutional layers, and one or more adapters, e.g., an adapter for each of the plurality of convolutional blocks, e.g., as part of a U-net architecture. The adapters can be inserted at any appropriate positions within the plurality of convolutional blocks. Each adapter can include any appropriate types of neural network layers (e.g., convolutional layers, fully connected layers, and so forth) in any appropriate number (e.g., 1 layer, or 2 layers, or 5 layers).

In these implementations, the one or more first sets of parameters 142 that are shared across different styles include the parameters of the plurality of convolutional blocks. The one or more second sets of parameters, e.g., the one or more second sets of parameters 144a, that are specific to the particular style include the parameters of neural network layers included in each of the one or more adapters.

For example, when the text-to-image generative model 120 is configured to generate an output image by iteratively predicting masked tokens, the image generation system 100 can fine-tune the text-to-image generative model 120 on the fine-tuning data 150 to learn the values of the one or more second sets of parameters that are specific to the particular style by optimizing a cross-entropy fine-tuning objective function as follows:

$$θ = {arg min}_{θ ∈ Θ} {L}_{θ} , {L}_{θ} = {𝔼}_{( x , t ) \sim {𝒟}_{tr} , m \sim ℳ} [ {CE}_{m} ( \hat{G} ( M ( E ( x ) , m ) , T ( t ) , θ ) , E ( x ) ) ]$$

where θ represents the one or more second sets of parameters that are specific to the particular style; G represents the original version of the text-to-image generative model 120 that includes one or more first sets of parameters that are shared across different styles; Ĝ represents the fine-tuned version of the text-to-image generative model 120 that includes both the one or more first sets of parameters and the one or more second sets of parameters; E represents the image encoder neural network, T represents the text encoder neural network which maps a text prompt t∈T included in each image-text pair to one or more text embeddings in a continuous embedding space E; Dₜᵣ is the fine-tuning data that includes one or more image-text pairs; M is a masking operator that replaces discrete visual tokens selected from a given vocabulary of discrete visual tokens v∈V with masked discrete visual tokens; and CEₘ is a weighted cross-entropy loss calculated by summing the cross-entropy loss computed for the predicted discrete visual tokens.

Specifically, the cross-entropy fine-tuning objective function in this example evaluates, for each image-text pair included in the fine-tuning data Dₜᵣ, a difference between (i) target discrete visual tokens generated by an image encoder neural network from the image included in the image-text pair and (ii) predicted discrete visual tokens generated by using the text-to-image generative model based on the text included in the image-text pair and the masked discrete visual tokens.

In particular, during the fine-tuning process, the image generation system 100 updates the values of the one or more second sets of parameters while holding the values (e.g., the pre-trained values) of the one or more first sets of parameters 142 that are shared across different styles, fixed. In the example of FIG. 1C, the image generation system 100 can use the fine-tuning data 150 to generate updated values for the parameters of the neural network layers included in the adapters of the text-to-image generative model 120, and holds the values of the parameters of the self-attention layers and cross-attention layers fixed to their pre-trained values.

The image generation system 100 can incorporate any number of techniques to improve the speed, the effectiveness, or both of the fine-tuning process. For example, the system can use weight sharing when updating the parameters of the neural network layers included in the adapters of the text-to-image generative model 120. That is, at any time point during the fine-tuning process, the parameters of the neural network layers included in one of the adapters will have the same values as the parameters of the neural network layers included in any other one of the adapters included in the text-to-image generative model 120. Suppose weight sharing is applied in the example of FIG. 1C, the total number of trainable parameters during the fine-tuning process would (approximately) be reduced by L, the number of Transformer blocks.

Once the fine-tuning adaptation is complete, the image generation system 100 can deploy the fine-tuned text-to-image generative model 120 and use the model to generate new images that have the particular style according to text prompts submitted by the users into the system. Alternatively or in addition, the image generation system 100 can provide data specifying the fine-tuned text-to-image generative model 120, e.g., data specifying the updated values of the one or more second sets of parameters and, in some cases, the architecture of the adapters included in the text-to-image generative model 120, for deployment for performing the conditional image generation task on another system, i.e., to generate new images that have the particular style.

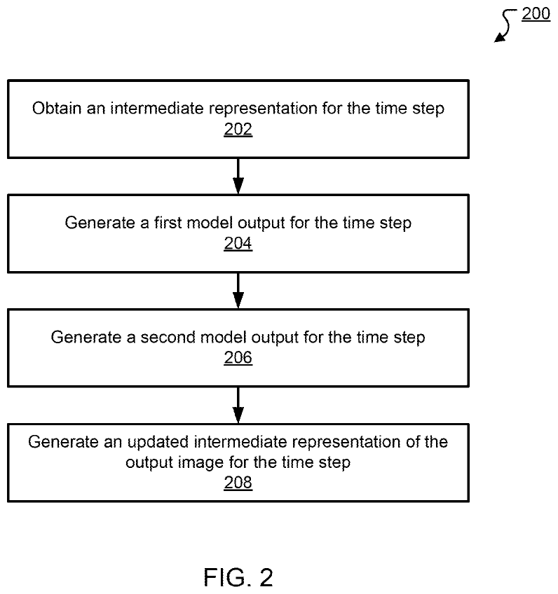

FIG. 2 is a flow diagram of an example process 200 for generating an output image by using a text-to-image generative model. For convenience, the process 200 will be described as being performed by a system of one or more computers located in one or more locations. For example, an image generation system, e.g., the image generation system 100 depicted in FIG. 1B, appropriately programmed in accordance with this specification, can perform the process 200.

The text-to-image generative model includes one or more first sets of parameters that are shared across different styles. The text-to-image generative model also includes one or more second sets of parameters that are specific to the particular style.

In the example of FIG. 2, the text-to-image generative model is configured to generate output images by iteratively predicting masked tokens. In implementations the text-to-image generative model can be configured as a Muse text-to-image model (as referenced above) or another masked generative Transformer model.

In some implementations, the text-to-image generative model include multiple Transformer blocks. Each Transformer block includes (i) one or more attention layers, e.g., self-attention layers, cross-attention layers, or both and (ii) an adapter that includes one or more neural network layers.

In these implementations, the one or more first sets of parameters can include parameters of the one or more attention layers included in each of the multiple Transformer blocks, and the one or more second sets of parameters can include parameters of the one or more neural network layers included in the adapter in each of the multiple Transformer blocks.

To generate the output image, the system uses the text-to-image generative model to repeatedly perform an iteration of the process 200 to update an intermediate representation of the output image at each of multiple decoding steps over a decoding process. That is, the process 200 can be performed at each of the multiple decoding steps over the decoding process. By repeatedly performing iterations of the process 200, the system can generate the output image.

Prior to first iteration of the process 200, i.e., prior to the first decoding step, the system receives a text prompt and then processes the text prompt using a text encoder neural network to generate a contextual text embedding based on the text prompt. The text prompt specifies a particular style that the output image should have. Optionally, in some cases, the text prompt also includes a negative prompt that specifies the content, e.g., objects, that should not appear in the output image.

The system obtains an intermediate representation of the output image for the decoding step (step 202). If the decoding step is the first decoding step in the decoding process, the intermediate representation is an initial intermediate representation. For any subsequent decoding step, the intermediate representation is the updated intermediate representation that has been generated in the immediately preceding decoding step.

The initial intermediate representation and the updated intermediate representations have the same dimensionality as each other but have different values. That is, the initial intermediate representation includes multiple variables, and the updated intermediate representation includes the same number of variables, but the values for these variables will generally differ.

The initial intermediate representation, which is the same dimensionality as the updated intermediate representations, can be composed entirely of “mask” tokens. A mask token is a token of an intermediate representation that signifies that the corresponding token in the final intermediate representation has not been selected yet.

A “token” can represent an individual data element from a discrete (e.g., finite) set of data elements. For example, a token can be or represent one of a vocabulary of discrete visual tokens corresponding to a codebook. To that end, a token can be in the form of an ordered collection of numerical values. For example, each token can include one or more numerical values. Examples of such a codebook and discrete visual tokens that correspond to the codebook are descried in Huiwen Chang, et al. Muse: Text-to-image generation via masked generative transformers. arXiv preprint arXiv:2301.00704, 2023 and Huiwen Chang, et al. Maskgit: Masked generative image transformer. arXiv preprint arXiv:2202.04200, 2022.

The system processes, by the text-to-image generative model and by using both the one or more first sets of parameters and the one or more second sets of parameters, the intermediate representation of the output image for the decoding step and the contextual text embedding to generate a first model output for the decoding step (step 204). That is, the system performs a first forward pass through the one or more attention layers and the adapter included in each of the multiple Transformer blocks included in the text-to-image generative model using the intermediate representation and the contextual text embedding.

The first model output can include, for each of a plurality of spatially distinct positions in the image, a respective set of logits over the indices of a given codebook. The codebook can define a mapping between discrete visual tokens in a given vocabulary of discrete visual tokens that corresponds to the given codebook and their corresponding indices. The respective set of logits can include a logit score for each of multiple indices in the given codebook. For example, the system can generate a respective set of logits for each image patch of the output image.

The system processes, by the text-to-image generative model and by using the one or more first sets of parameters and without using the one or more second sets of parameters, the intermediate representation of the output image for the decoding step and the contextual text embedding to generate a second model output for the decoding step (step 206). That is, the system performs a second forward pass through the one or more attention layers included in each of the multiple Transformer blocks included in the text-to-image generative model using the intermediate representation and the contextual text embedding. In particular, the adapters are not used to process the intermediate representation (or data derived from the intermediate representation) in the second forward pass.

Like the first model output, the second model output can include, for each of the plurality of spatially distinct positions in the image, a respective set of logits over the indices of the given codebook. Because different sets of parameters of the text-to-image generative model are used to generate the first and the second model outputs, however, the respective set of logits included in the second model output will be generally differ from the respective set of logits included in the first model output.

At step 204 or step 206, when the one or more attention layers include one or more cross-attention layers, each cross-attention layer can apply a cross-attention mechanism over the output of a preceding layer, e.g., the output of a self-attention layer or another cross-attention layer, and the contextual text embedding to generate an output of the cross-attention layer.

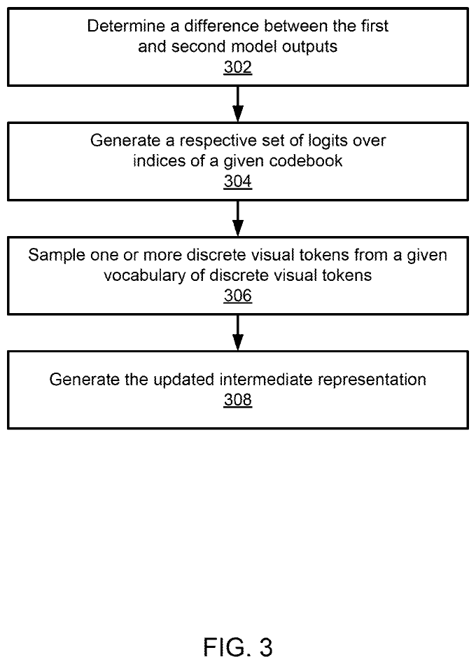

The system generates an updated intermediate representation of the output image for the decoding step based on the first and second model outputs for the decoding step (step 208). Generating the updated intermediate representation is described below with reference to FIG. 3, which is a flow diagram of sub-steps of step 208 of the process of FIG. 2.

The system determines a difference between the first model output and the second model output for the decoding step (step 302). Such a difference can include, for each of the plurality of spatially distinct positions in the image, a difference between the respective set of logits included in the first model output and the respective set of logits included in the second model output.

The system generates, based at least in part on the difference, a respective set of logits over indices of the given codebook for each of a plurality of spatially distinct positions in the output image (step 304).

For example, for any position in the image, the set of logits can be computed as

$${l}_{k} = \hat{G} ( {v}_{k} , T ( t ) , θ ) + {λ}_{A} ( \hat{G} ( {v}_{k} , T ( t ) , θ ) - G ( {v}_{k} , T ( t ) ) ) + {λ}_{B} ( G ( {v}_{k} , T ( t ) ) - G ( {v}_{k} , T ( n ) ) )$$

where Ĝ(vₖ,T(t),θ) is the first model output (that has been generated by using both the one or more first sets of parameters and the one or more second sets of parameters) and G(vₖ,T(t)) is the second model output (that has been generated by using the one or more first sets of parameters and without using the one or more second sets of parameters); v∈V represents discrete visual tokens from a vocabulary of visual tokens; k denotes the decoding step in the decoding process; n∈T is a negative prompt (a text prompt that specifies the content, e.g., objects, that should not appear in the output image); λ_{A} is a guidance scale factor that controls the level of adaptation to the target distribution by contrasting the first and second model outputs; and λ_{B} is a guidance scale factor that controls the textual alignment by contrasting the second model output and another model output generated based on the negative prompt by using the one or more first sets of parameters and without using the one or more second sets of parameters.

For each of at least some the plurality of spatially distinct positions in the output image, the system samples, in accordance with the respective set of logits, one or more discrete visual tokens from the given vocabulary of discrete visual tokens corresponding to the given codebook (step 306). For example, the system can determine an index by greedily selecting the highest-scoring index or through sampling, e.g., using nucleus sampling or another sampling technique, from the respective set of logits that have been computed in step 304, and then use the discrete visual token that maps to the determined index as a corresponding, sampled discrete visual token.

At each decoding step, the system generally samples one or more discrete visual tokens for each of at least one, but fewer than all, of the multiple spatially distinct positions in the output image. In some implementations, at each decoding step, the system can select discrete visual tokens for each of a corresponding number of images patches with the highest logit scores (e.g., measured by highest logit score for any token in the vocabulary) among all images patches included in the output image. The corresponding number of images patches at each decoding step can be determined in accordance with a predetermined schedule, e.g., a cosine schedule, an exponential schedule, a square schedule, or a linear schedule, that is defined across the multiple decoding steps in the decoding process.

In some implementations, the system can perform the sampling of the one or more discrete visual tokens for each spatially distinct position in the output image independently of and in parallel with the sampling of the one or more discrete visual tokens for other spatially distinct positions. That is, multiple discrete visual tokens can be sampled for different positions in the output image at the same time.

The system generates the updated intermediate representation by replacing the mask tokens that reside at some of the plurality of spatially distinct positions in the output image with the sampled discrete visual tokens (step 308). The updated intermediate representation thus includes the one or more sampled discrete visual tokens in place of the mask tokens that were previously included in the intermediate representation. In this way, at each decoding step, the system generates a new updated intermediate representation that has fewer mask tokens.

Turning back to FIG. 2, when the decoding step is not the last decoding step in the decoding process, the system can perform a next iteration of the process 200, where the updated intermediate representation will be used as the intermediate representation in the next iteration of the process 200. Alternatively, when the decoding step is the last decoding step, the system can perform further processing on the updated intermediate representation to generate the output image.

For example, the system can process the updated intermediate representation using a decoder neural network to generate a decoder output and use the decoder output as the output image. The decoder neural network can have been configured through training to map the discrete visual token for each spatially distinct position in the output image to one or more pixel values for the position. In another example, the updated intermediate representation at the last step corresponds to the output image.

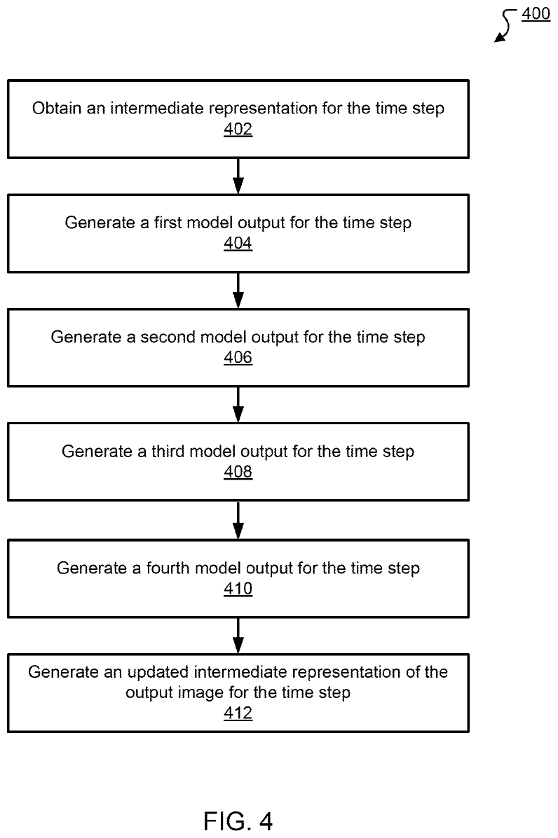

FIG. 4 is a flow diagram of another example process 400 for generating an output image by using a text-to-image generative model. For convenience, the process 400 will be described as being performed by a system of one or more computers located in one or more locations. For example, an image generation system, e.g., the image generation system 100 depicted in FIG. 1B, appropriately programmed in accordance with this specification, can perform the process 400. Process 400 differs from process 200 in that it extends the conditional image generation capability of the system to additionally enable generating new images that not only have the particular style, but also depict particular content, e.g. specific instances of a particular object.

The text-to-image generative model includes one or more first sets of parameters that are shared across different styles. The text-to-image generative model includes one or more second sets of parameters that are specific to a particular style. The text-to-image generative model further includes one or more third sets of parameters that are specific to a particular object or instance of an object. In the example of FIG. 4, the text-to-image generative model is configured to generate output images by iteratively predicting masked tokens. In implementations the text-to-image generative model can be configured as a Muse text-to-image model (as referenced above) or another masked generative Transformer model.

In some implementations, the text-to-image generative model include multiple Transformer blocks. Each Transformer block includes (i) one or more attention layers, e.g., self-attention layers, cross-attention layers, or both and (ii) two adapters (a first adapter and a second adapter) that each include one or more neural network layers, e.g. one adapter for adapting to the particular style and one adapter for adapting to the particular object/instance.

In these implementations, the one or more first sets of parameters can include parameters of the one or more attention layers included in each of the multiple Transformer blocks, the one or more second sets of parameters can include parameters of the one or more neural network layers included in the first adapter in each of the multiple Transformer blocks, and the one or more third sets of parameters can include parameters of the one or more neural network layers included in the second adapter in each of the multiple Transformer blocks.

To generate the output image, the system uses the text-to-image generative model to repeatedly perform an iteration of the process 400 to update an intermediate representation of the output image at each of multiple decoding steps over a decoding process. That is, the process 400 can be performed at each of the multiple decoding steps over the decoding process. By repeatedly performing iterations of the process 400, the system can generate the output image.

Prior to first iteration of the process 400, i.e., prior to the first decoding step, the system receives a text prompt that specifies a particular style that the output image should have and that specifies a particular object/instance that should be depicted in the output image. Optionally, in some cases, the text prompt also includes a negative prompt that specifies the content, e.g., objects, that should not appear in the output image.

The system then processes at least a portion of the text prompt, e.g., the portion that includes the description of the particular style, using a text encoder neural network to generate a contextual text embedding. The system also processes at least a portion of the text prompt, e.g., the portion that includes the description of the particular object/instance, using the text encoder neural network to generate an object text embedding.

The system obtains an intermediate representation of the output image for the decoding step (step 402). If the decoding step is the first decoding step in the decoding process, the intermediate representation is an initial intermediate representation. For any subsequent decoding step, the intermediate representation is the updated intermediate representation that has been generated in the immediately preceding decoding step. The initial intermediate representation has the same dimensionality as the updated intermediate representation and is composed entirely of “mask” tokens.

The system processes, by the text-to-image generative model and by using both the one or more first sets of parameters and the one or more second sets of parameters, the intermediate representation of the output image for the decoding step and the contextual text embedding to generate a first model output for the decoding step (step 404). That is, the system performs a first forward pass through the one or more attention layers and the first adapter included in each of the multiple Transformer blocks included in the text-to-image generative model using the intermediate representation and the contextual text embedding.

The first model output can include, for each of a plurality of spatially distinct positions in the image, a respective set of logits over the indices of a given codebook (which can be the same codebook as mentioned above with reference to FIG. 2). For example, the system can generate a respective set of logits for each image patch of the output image.

The system processes, by the text-to-image generative model and by using the one or more first sets of parameters and without using either the one or more second sets of parameters or the one or more third sets of parameters, the intermediate representation of the output image for the decoding step and the contextual text embedding to generate a second model output for the decoding step (step 406). That is, the system performs a second forward pass through the one or more attention layers included in each of the multiple Transformer blocks included in the text-to-image generative model using the intermediate representation and the contextual text embedding. In particular, the first and second adapters are not used to process the intermediate representation (or data derived from the intermediate representation) in the second forward pass.

The second model output can include, for each of the plurality of spatially distinct positions in the image, a respective set of logits over the indices of the given codebook. The respective set of logits included in the second model output will generally differ from the respective set of logits included in the first model output.

The system processes, by the text-to-image generative model and by using both the one or more first sets of parameters and the one or more third sets of parameters, the intermediate representation of the output image for the decoding step and the object text embedding to generate a third model output for the decoding step (step 408). That is, the system performs a third forward pass through the one or more attention layers and the second adapter included in each of the multiple Transformer blocks included in the text-to-image generative model using the intermediate representation and the object text embedding.

The third model output can include, for each of the plurality of spatially distinct positions in the image, a respective set of logits over the indices of the given codebook. The respective set of logits included in the third model output will generally differ from the respective set of logits included in the second model output, and further from the respective set of logits included in the first model output.

The system processes, by the text-to-image generative model and by using the one or more first sets of parameters and without using either the one or more second sets of parameters or the one or more third sets of parameters, the intermediate representation of the output image for the decoding step and the object text embedding to generate a fourth model output for the decoding step (step 410). That is, the system performs a fourth forward pass through the one or more attention layers included in each of the multiple Transformer blocks included in the text-to-image generative model using the intermediate representation and the object text embedding. In particular, the first and second adapters are not used to process the intermediate representation (or data derived from the intermediate representation) in the fourth forward pass.

The fourth model output can include, for each of the plurality of spatially distinct positions in the image, a respective set of logits over the indices of the given codebook. The respective set of logits included in the fourth model output will generally differ from the respective set of logits included in the third second model output, from the respective set of logits included in the second model output, and further from the respective set of logits included in the first model output.

At step 404, step 406, step 408, or step 410, when the one or more attention layers include one or more cross-attention layers, each cross-attention layer can apply a cross-attention mechanism over the output of a preceding layer, e.g., the output of a self-attention layer or another cross-attention layer, and the contextual text embedding (or the object text embedding) to generate an output of the cross-attention layer.

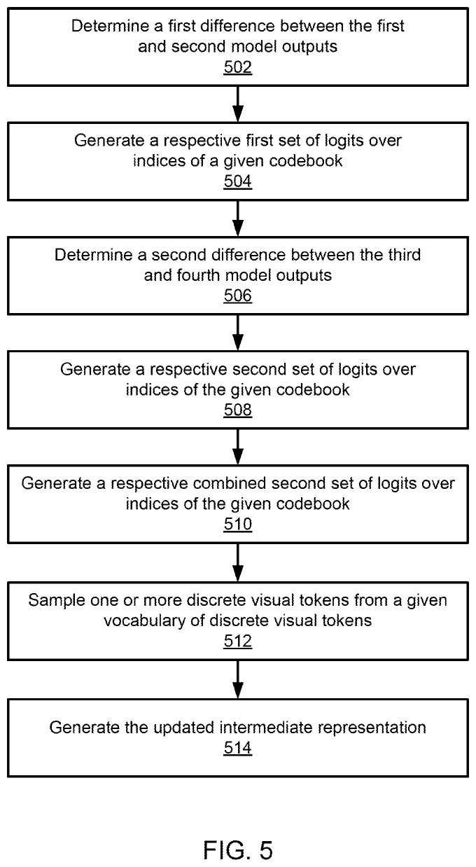

The system generates an updated intermediate representation of the output image for the decoding step based on the first, second, third, and fourth model outputs for the decoding step (step 412). Generating the updated intermediate representation is described below with reference to FIG. 5, which is a flow diagram of sub-steps of step 412 of the process of FIG. 4.

The system determines a first difference between the first model output and the second model output for the decoding step (step 502).

The system generates, based at least in part on the first difference, a respective first set of logits over indices of the given codebook for each of the plurality of spatially distinct positions in the output image (step 504). For example, the system can generate a respective first set of logits for each image patch of the output image.

For example, for any position in the output image, the first set of logits can be computed as

$${l}_{k}^{s} = \hat{G} ( {v}_{k} , T ( t ) , {θ}_{s} ) + {λ}_{A} ( \hat{G} ( {v}_{k} , T ( t ) , {θ}_{s} ) - G ( {v}_{k} , T ( t ) ) ) + {λ}_{B} ( G ( {v}_{k} , T ( t ) ) - G ( {v}_{k} , T ( n ) ) )$$

where Ĝ(vₖ,T(t),θₛ) is the first model output (that has been generated based on the contextual text embedding by using both the one or more first sets of parameters and the one or more second sets of parameters) and G(vₖ,T(t)) is the second model output (that has been generated based on the contextual text embedding by using the one or more first sets of parameters and without either the one or more second sets of parameters or the one or more third sets of parameters).

The system determines a second difference between the third model output and the fourth model output for the decoding step (step 506).

The system generates, based at least in part on the second difference, a respective second set of logits over the indices of the given codebook for each of the plurality of spatially distinct positions in the image (step 508). For example, the system can generate a respective second set of logits for each image patch of the output image.

For example, for any position in the image, the second set of logits can be computed as

$${l}_{k}^{c} = \hat{G} ( {v}_{k} , T ( c ) , {θ}_{c} ) + {λ}_{A} ( \hat{G} ( {v}_{k} , T ( c ) , {θ}_{c} ) - G ( {v}_{k} , T ( c ) ) ) + {λ}_{B} ( G ( {v}_{k} , T ( c ) ) - G ( {v}_{k} , T ( n ) ) )$$

where Ĝ(vₖ,T(c),θ_{c}) is the third model output (that has been generated based on the object text embedding by using both the one or more first sets of parameters and the one or more third sets of parameters) and G(vₖ,T(c))) is the fourth model output (that has been generated based on the object text embedding by using the one or more first sets of parameters and without using either the one or more second sets of parameters or the one or more third sets of parameters).

The system generates, from the respective first and second sets of logits, a respective combined set of logits over the indices of the given codebook for each of the plurality of spatially distinct positions in the output image (step 510). For example, for any position in the output image, the respective combined set of logits can be computed as:

$${l}_{k} = ( 1 - γ ) {l}_{k}^{s} + γ {l}_{k}^{c} ,$$

where γ balances between the guidance of the description of the particular object/instance and the description of the particular style on the decoding process: if γ is 0, the output image will have the particular style specified by the text prompt, and if γ is 1, the output image will depict the particular object/instance specified by the text prompt. By setting γ to have an appropriate value (e.g., between 0.5 and 0.7), the output image will both have the particular style and depict the particular object.

For each of at least some the plurality of spatially distinct positions in the output image, the system samples, in accordance with the respective combined set of logits, one or more discrete visual tokens from the given vocabulary of discrete visual tokens corresponding to the given codebook (step 512). For example, the system can determine an index by greedily selecting the highest-scoring index or through sampling, e.g., using nucleus sampling or another sampling technique, from the respective combined set of logits that have been computed in step 510, and then use the discrete visual token that maps to the determined index as a corresponding, sampled discrete visual token.

The system generates the updated intermediate representation by replacing the mask tokens that reside at some of the plurality of spatially distinct positions in the output image with the sampled discrete visual tokens (step 514). The updated intermediate representation thus includes the one or more sampled discrete visual tokens in place of the mask tokens that were previously included in the intermediate representation. In this way, at each decoding step, the system generates a new updated intermediate representation that has fewer mask tokens.

Turning back to FIG. 4, when the decoding step is not the last decoding step in the decoding process, the system can perform a next iteration of the process 400, where the updated intermediate representation will be used as the intermediate representation in the next iteration of the process 400. Alternatively, when the decoding step is the last decoding step, the system performs further processing on the updated intermediate representation to generate the output image.

For example, the system can process the updated intermediate representation using a decoder neural network to generate a decoder output and use the decoder output as the output image. The decoder neural network can have been configured through training to map the discrete visual token for each spatially distinct position in the image to one or more pixel values for the position. In another example, the updated intermediate representation at the last decoding step corresponds to the output image.

The examples in this specification generally discuss using a text-to-image generative model that has a Transformer architecture to execute a decoding process to generate an output image. However, the same techniques can also be applied to any other appropriate text-to-image generative model, e.g., a convolutional neural network that has a U-Net architecture, and to execute any other conditional image generation process that generates an output image by iteratively updating an initial intermediate representation of the output image, e.g., to execute a reverse diffusion process in either a pixel space or a latent space.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following numbered clauses:
Clause 1. A computer-implemented method comprising:
   receiving a text prompt specifying a style of an image;
   processing the text prompt using a text encoder neural network to generate a contextual text embedding; and
   generating an output image by using a text-to-image generative model, wherein the text-to-image generative model comprises one or more first sets of parameters that are shared across different styles, and one or more second sets of parameters that are specific to the specified style, and wherein the generating comprises, at each of multiple time steps:
      obtaining an intermediate representation of the output image for the time step;
      processing, by the text-to-image generative model and by using both the one or more first sets of parameters and the one or more second sets of parameters, the intermediate representation of the output image for the time step and the contextual text embedding to generate a first model output for the time step;
      processing, by the text-to-image generative model and by using the one or more first sets of parameters and without using the one or more second sets of parameters, the intermediate representation of the output image for the time step and the contextual text embedding to generate a second model output for the time step; and
      generating an updated intermediate representation of the output image for the time step based on the first and second model outputs for the time step.
Clause 2. The method of clause 1, wherein the text-to-image generative model comprises a plurality of Transformer layers each configured to process an input token sequence and the intermediate representation to generate an updated token sequence based on applying an attention mechanism.
Clause 3. The method of clause 2, wherein each Transformer layer comprises (i) one or more attention layers having parameters that are included in the first sets of parameters shared across different styles and (ii) an adapter having parameters that are included in the second sets of parameters that are specific to the style.
Clause 4. The method of clause 3, wherein the one or more attention layers comprise one or more self-attention layers, one or more cross-attention layers, or both.
Clause 5. The method of any one of clauses 1-4, wherein a total number of the one or more first sets of parameters is greater than a total number of the one or more second sets of parameters.
Clause 6. The method of any one of clauses 1-5, wherein generating the updated intermediate representation of the output image for the time step comprises:
   determining a difference between the first and second model outputs for the time step;
   generating, based at least in part on the difference, a respective set of logits over indices of a given codebook for each of a plurality of spatially distinct positions in the image;
   sampling, in accordance with the respective sets of logits, one or more discrete visual tokens from a given vocabulary of discrete visual tokens corresponding to the given codebook; and
   generating the updated intermediate representation that comprises the one or more sampled discrete visual tokens in place of mask visual tokens at at least some of the plurality of spatially distinct positions in the image.
Clause 7. The method of clause 6, wherein sampling the sequence of discrete visual tokens comprises:
   sampling a discrete visual token for each spatially distinct position in the image in parallel with other discrete visual tokens.
Clause 8. The method of any one of clauses 1-7, wherein generating the output image comprises:
   processing the updated intermediate representation of the output image generated at a last time step using a decoder neural network to map the discrete visual token for each spatially distinct position in the image to one or more pixel values for the position.
Clause 9. The method of any one of clauses 1-8, further comprising:
   prior to generating the output image, fine-tuning the text-to-image generative model on fine-tune data comprising one or more image-text pairs, wherein each image-text pair comprises an image and a text prompt that includes both a description of a content of the image and a description of a style of the image, and wherein the fine-tuning comprises learning updated values of the one or more second sets of parameters while holding pre-trained values of the one or more first sets of parameters fixed.
Clause 10. The method of clause 9, wherein fine-tuning the text-to-image generative model comprises training the text-to-image generative model on the fine-tune data to optimize a cross-entropy loss function that evaluates, for each image-text pair, a difference between (i) a target discrete visual token generated by an image encoder from the image included in the image-text pair and (ii) a predicted discrete visual token generated by the text-to-image generative model based on the text included in the image-text pair.
Clause 11. A computer-implemented method comprising:
   receiving a text prompt that includes both a description of a particular object and a description of a particular style of an image;
   processing the text prompt using the text encoder neural network to generate a contextual text embedding;
   processing the description of the particular object using the text encoder neural network to generate an object text embedding; and
   generating an output image by using a text-to-image generative model, wherein the text-to-image generative model comprises one or more first sets of parameters that are shared across different styles, one or more second sets of parameters that are specific to the particular style, and one or more third sets of parameters that are specific to the particular object, and wherein the generating comprises, at each of multiple time steps:
      obtaining an intermediate representation of the output image for the time step;
      processing, by the text-to-image generative model and by using both the one or more first sets of parameters and the one or more second sets of parameters, the intermediate representation of the output image for the time step and the contextual text embedding to generate a first model output for the time step;
      processing, by the text-to-image generative model and by using the one or more first sets of parameters and without using either the one or more second sets of parameters or the one or more third sets of parameters, the intermediate representation of the output image for the time step and the contextual text embedding to generate a second model output for the time step;
      processing, by the text-to-image generative model and by using both the one or more first sets of parameters and the one or more third sets of parameters, the intermediate representation of the output image for the time step and the object text embedding to generate a third model output for the time step;
      processing, by the text-to-image generative model and by using the one or more first sets of parameters and without using either the one or more second sets of parameters or the one or more third sets of parameters, the intermediate representation of the output image for the time step and the object text embedding to generate a fourth model output for the time step; and
      generating an updated intermediate representation of the output image for the time step based on the first, second, third, and fourth model outputs for the time step.
Clause 12. The method of clause 11, wherein generating the updated intermediate representation of the output image for the time step comprises:
   determining a first difference between the first and second model outputs for the time step;
   generating, based at least in part on the first difference, a respective first set of logits over indices of a given codebook for each of a plurality of spatially distinct positions in the image;
   determining a second difference between the third and fourth model outputs for the time step;
   generating, based at least in part on the second difference, a respective second set of logits over the indices of the given codebook for each of the plurality of spatially distinct positions in the image;
   generating, from the respective first and second sets of logits, a respective combined set of logits over the indices of the given codebook for each of the plurality of spatially distinct positions in the image;
   sampling, in accordance with the respective combined sets of logits, one or more discrete visual tokens from a given vocabulary of discrete visual tokens corresponding to the given codebook; and
   generating the updated intermediate representation that comprises the one or more sampled discrete visual tokens in place of mask visual tokens at at least some of the plurality of spatially distinct positions in the image.
Clause 13. A system comprising one or more computers and one or more storage devices storing instructions that are operable, when executed by the one or more computers, to cause the one or more computers to perform the operations of the respective method of any preceding clause.
Clause 14. A computer storage medium encoded with instructions that, when executed by one or more computers, cause the one or more computers to perform the operations of the respective method of any preceding clause.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
receiving a text prompt specifying a style of an image;
processing the text prompt using a text encoder neural network to generate a contextual text embedding; and
generating an output image by using a text-to-image generative model, wherein the text-to-image generative model comprises one or more first sets of parameters that are shared across different styles, and one or more second sets of parameters that are specific to the specified style, and wherein the generating comprises, at each of multiple steps:
obtaining an intermediate representation of the output image for the step;
processing, by the text-to-image generative model and by using both the one or more first sets of parameters and the one or more second sets of parameters, the intermediate representation of the output image for the step and the contextual text embedding to generate a first model output for the step;
processing, by the text-to-image generative model and by using the one or more first sets of parameters and without using the one or more second sets of parameters, the intermediate representation of the output image for the step and the contextual text embedding to generate a second model output for the step; and
generating an updated intermediate representation of the output image for the step based on the first and second model outputs for the step.

2. The method of claim 1, wherein the text-to-image generative model comprises a plurality of Transformer block each configured to process a block input derived from the intermediate representation to generate a block output based on applying an attention mechanism.

3. The method of claim 2, wherein each Transformer block comprises (i) one or more attention layers having parameters that are included in the first sets of parameters shared across different styles and (ii) an adapter having parameters that are included in the second sets of parameters that are specific to the style.

4. The method of claim 3, wherein the one or more attention layers comprise one or more self-attention layers, one or more cross-attention layers, or both.

5. The method of claim 1, wherein a total number of the one or more first sets of parameters is greater than a total number of the one or more second sets of parameters.

6. The method of claim 1, wherein generating the updated intermediate representation of the output image for the step comprises:
determining a difference between the first and second model outputs for the step;
generating, based at least in part on the difference, a respective set of logits over indices of a given codebook for each of a plurality of spatially distinct positions in the image;
sampling, in accordance with the respective sets of logits, one or more discrete visual tokens from a given vocabulary of discrete visual tokens corresponding to the given codebook; and
generating the updated intermediate representation that comprises the one or more sampled discrete visual tokens in place of mask tokens at at least some of the plurality of spatially distinct positions in the image.

7. The method of claim 6, wherein sampling the sequence of discrete visual tokens comprises:
sampling a discrete visual token for each spatially distinct position in the image in parallel with other discrete visual tokens.

8. The method of claim 1, wherein generating the output image comprises:
processing the updated intermediate representation of the output image generated at a last step using a decoder neural network to map the discrete visual token for each spatially distinct position in the image to one or more pixel values for the position.

9. The method of claim 1, further comprising:
prior to generating the output image, fine-tuning the text-to-image generative model on fine-tuning data comprising one or more image-text pairs, wherein each image-text pair comprises an image and a text prompt that includes both a description of a content of the image and a description of a style of the image, and wherein the fine-tuning comprises learning updated values of the one or more second sets of parameters while holding pre-trained values of the one or more first sets of parameters fixed.

10. The method of claim 9, wherein fine-tuning the text-to-image generative model comprises training the text-to-image generative model on the fine-tuning data to optimize a cross-entropy loss function that evaluates, for each image-text pair, a difference between (i) a target discrete visual token generated by an image encoder from the image included in the image-text pair and (ii) a predicted discrete visual token generated by the text-to-image generative model based on the text included in the image-text pair.

11. A computer-implemented method comprising:
receiving a text prompt that includes both a description of a particular object and a description of a particular style of an image;
processing the description of the particular style using the text encoder neural network to generate a contextual text embedding;
processing the description of the particular object using the text encoder neural network to generate an object text embedding; and
generating an output image by using a text-to-image generative model, wherein the text-to-image generative model comprises one or more first sets of parameters that are shared across different styles, one or more second sets of parameters that are specific to the particular style, and one or more third sets of parameters that are specific to the particular object, and wherein the generating comprises, at each of multiple steps:
obtaining an intermediate representation of the output image for the step;
processing, by the text-to-image generative model and by using both the one or more first sets of parameters and the one or more second sets of parameters, the intermediate representation of the output image for the step and the contextual text embedding to generate a first model output for the step;
processing, by the text-to-image generative model and by using the one or more first sets of parameters and without using either the one or more second sets of parameters or the one or more third sets of parameters, the intermediate representation of the output image for the step and the contextual text embedding to generate a second model output for the step;
processing, by the text-to-image generative model and by using both the one or more first sets of parameters and the one or more third sets of parameters, the intermediate representation of the output image for the step and the object text embedding to generate a third model output for the step;
processing, by the text-to-image generative model and by using the one or more first sets of parameters and without using either the one or more second sets of parameters or the one or more third sets of parameters, the intermediate representation of the output image for the step and the object text embedding to generate a fourth model output for the step; and
generating an updated intermediate representation of the output image for the step based on the first, second, third, and fourth model outputs for the step.

12. The method of claim 11, wherein generating the updated intermediate representation of the output image for the step comprises:
determining a first difference between the first and second model outputs for the step;
generating, based at least in part on the first difference, a respective first set of logits over indices of a given codebook for each of a plurality of spatially distinct positions in the image;
determining a second difference between the third and fourth model outputs for the step;
generating, based at least in part on the second difference, a respective second set of logits over the indices of the given codebook for each of the plurality of spatially distinct positions in the image;
generating, from the respective first and second sets of logits, a respective combined set of logits over the indices of the given codebook for each of the plurality of spatially distinct positions in the image;
sampling, in accordance with the respective combined sets of logits, one or more discrete visual tokens from a given vocabulary of discrete visual tokens corresponding to the given codebook; and
generating the updated intermediate representation that comprises the one or more sampled discrete visual tokens in place of mask visual tokens at at least some of the plurality of spatially distinct positions in the image.

13-20. (canceled)
